(19) United States
(12) Patent Application Publication
(10) Pub. No.: US 2008/0142300 A1
(43) Pub. Date: Jun. 19, 2008

(54) Work Piece Support

(76) Inventors: Albert E. Roberge, Kissimmee, FL (US); Gary R. Timbrell, St. Cloud, FL (US)

Correspondence Address: BOYLE FREDRICKSON S.C., 840 North Plankinton Avenue, MILWAUKEE, WI, 53203, US

(21) Appl. No.: 11/951,941

(22) Filed: Dec. 6, 2007

Related U.S. Application Data
(60) Provisional application No. 60/868,874, filed on Dec. 6, 2006.

(51) Int. Cl. E06C 7/14

(52) U.S. Cl. 182/129

(57) ABSTRACT

A work piece support of the present invention has at least one self-locking bracket. The self-locking bracket has a locking portion that engages the step of a ladder and a support portion that secures a work piece. The locking portion and support portion are joined together to create a self-contained unitary member. The at least one self-locking bracket may be used in conjunction with another to provide an optimal work piece support.

### CROSS REFERENCE TO RELATED APPLICATION

This application claims priority under 35 USC § 119 to provisional application U.S. Ser. No. 60/868,874, Entitled Work Piece Support Apparatus.

### BACKGROUND OF THE INVENTION

1. Field of the Invention

The present invention is directed to a work piece support and more particularly a self-locking, ladder mounted support having a narrow profile.

2. Description of Related Art

Technicians and ladders are an almost inescapable combination. Much of the work performed by technicians requires a ladder and the technicians must make multiple trips up and down the ladder to get the work pieces necessary for the task at hand. This process can be tiring and also reduce the technician's productivity as much of his time is spent climbing up and down the ladder. Additionally, it is often required to cut a work piece to an appropriate size. This may be accomplished by the technician using his leg as a brace for the work piece, however there are many obvious dangers inherent in this practice. This process can easily harm the technician and also result in an inaccurate cut if the work piece is not securely locked in place. Therefore, many different supports for work pieces have been developed to allow a technician to place a variety of work pieces on the support in close proximity to where the technician is working and that can serve as a brace when cutting a work piece. Some of these supports are ladder mounted.

Work piece supports mounted on the side upwardly extending supports of a ladder are well known in the art. These supports often allow the technician to mount the supports in almost any desired location on the ladder. However, these supports require the technician to fasten the mounts often by bolting them to the side supports of a ladder or by clamping them to the side supports of a ladder. This step adds additional time to the technician's job and it also reduces the reliability of these particular work piece supports. Once the support is loaded with a particularly heavy work piece, if the technician failed to adequately clamp it, the support could slip, allowing the work piece to fall out, causing damage to the property, technician, and possibly others. Furthermore, these work piece supports have multiple parts, which makes the support cumbersome, costly to produce, and reduces its portability, as pieces could be lost in transit.

Other work piece supports have been designed for mounting on the steps of a ladder. One such support has a portion designed to fit the profile of a ladder step and has a large section hanging down between the ladder supports to serve as a work piece support. Although this type of work piece support does not require a complicated process in order to mount it on the ladder there are many other inherent disadvantages. Namely, many of these work piece supports are rather large, inherently limiting portability, a critical objective. These supports have a wide profile and therefore take up a great deal of space between the ladder supports and can hang down over many steps. This prevents use of the ladder above the support mounting location. Overall, because of their relatively large size these supports cannot be stored in a toolbox, a pocket, or on a belt.

What is needed in the art is a self-locking work piece support that is easy to transport, preferably in a toolbox, a pocket, or on a belt, readily mountable to a ladder, and does not compromise use of the ladder by it's mounting thereon.

### SUMMARY OF THE INVENTION

According to the present invention the foregoing and other objects and advantages are obtained by a work piece support having at least one self-locking bracket. The self-locking bracket has a locking portion that engages the step of a ladder and a support portion that secures a work piece. The locking portion and support portion are joined together to create a self-contained unitary member. The at least one self-locking bracket may be used in conjunction with another to provide an optimal work piece support. Furthermore, in order to not inhibit full use of the ladder, the work piece support is preferably less than half the width of the step. More preferably, it is less than one quarter the width of the step. Most preferably, it is less than one eighth the width of the step.

According to one aspect of the embodiment, the support portion may be formed to have a v-shape cross-section. This design allows the support portion to accommodate work pieces of varying dimensions; specifically the v-shaped support portion can accommodate work pieces of varying diameters. This support portion may also be formed to have a step shaped profile to accommodate dimensional lumber.

According to another aspect of the embodiment, the self-locking portion is formed to generally correspond to the profile of a ladder step. Further, this self-locking portion may be formed to have a backside wall with a bottom portion. A lip extends from the bottom portion towards the support portion. Therefore, when the work piece support is mounted on a ladder step the lip extends under the step of the ladder and serves to lock the work piece support in place. The work piece support may also be formed to have sidewalls that engage the upright supports of the ladder, which are generally orthogonal to the steps. These features provide added stability to the work piece support.

The work piece support can take on a variety of shapes and sizes. All that is required is that it has at least a means for mounting and locking the support to the ladder and a means for supporting a work piece. These two sections are then unitarily formed to embody a work piece support of the present invention. Furthermore, the invention is preferably made from a polyethylene with at least some elasticity.

### BRIEF DESCRIPTION OF THE DRAWINGS

The preferred embodiments of the present invention will be described with reference to the following figures, wherein like numerals designate like elements, and wherein:

FIG. 1 is a perspective view of a mounted work piece support apparatus according to one preferred embodiment;

FIG. 2 is a side elevation cross-sectional view of a work piece support mounted on a step according to one preferred embodiment;

FIG. 3 is a front elevation view of a mounted work piece support apparatus according to one preferred embodiment;

FIG. 4 is a side elevational view of a work piece support having an alternate shape;

FIG. 5 is a top view of the work piece support of FIG. 4; and

FIG. 6 is a perspective view of the work piece support of FIG. 4.

### DETAILED DESCRIPTION OF THE PREFERRED EMBODIMENTS

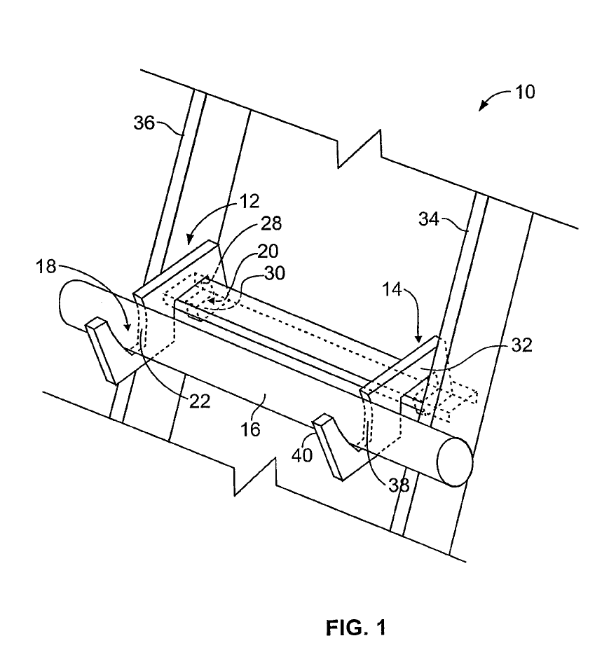

A work piece support apparatus 10 constructed in accordance with the present invention is shown in FIGS. 1-3. The work piece support apparatus 10 preferably has two identical self-locking brackets 12, 14 mounted on opposite sides of the same ladder step 16 mounted to opposed upwardly extending supports 34, 36 of the ladder, as best seen in FIGS. 1 and 3. Since the self-locking brackets 12, 14 are identical it is understood that by describing one self-locking bracket 12 the other self-locking bracket is sufficiently described.

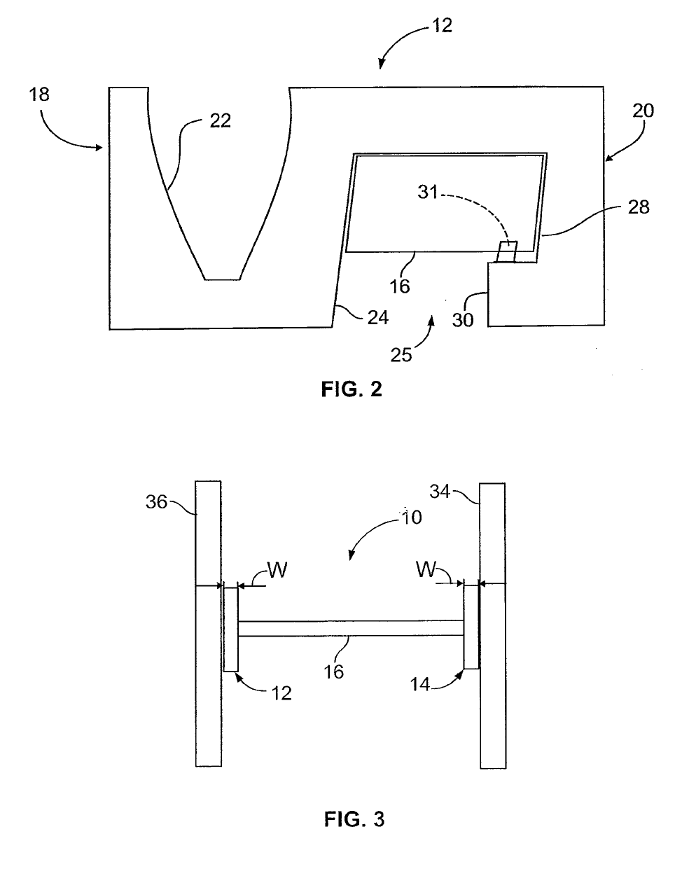

As best seen in FIG. 2, the self-locking bracket 12 has two main portions, a support portion 18 and a locking portion 20. The support portion 18 preferably has a substantially v-shaped channel 22, which can accommodate a variety of work piece dimensions. Preferably, the v-shaped channel 22 is dimensioned such that it can accommodate conduits of varying diameters.

The locking portion 20 of the self-locking bracket 12 has a front wall 24, a top wall 26, a rear wall 28, and a lip 30. When engaging a step 16, as shown in FIGS. 1 and 2, these four parts of the locking portion 20 encase a significant portion of the step 16.

To mount the self-locking bracket 12 the step 16 must be slid in between the front wall 24 and the distal end of the lip 30. However, the front wall 24 and the distal end of the lip 30 are preferably distanced such that the gap 25 between them is narrower than a common ladder step 16. Therefore, the self-mounting bracket 12 is preferably, though not necessarily, formed from a polyethylene with at least some elasticity, which allows the locking portion 20 to momentarily expand when being mounted on a ladder step 16. Once the step 16 has passed through this gap the locking portion 20 will spring back to its original dimensions if it had expanded. Notably, locking portion 20 will not likely expand if the gap 25 between front wall 24 and distal end of lip 30 is designed to be at least slightly larger than the height of step 16, allowing bracket 12 to be readily “worked” around step 16. As best seen in FIG. 1, the lip 30 then slides under the bottom of the step 16 and the front 24, top 26, and rear 28 walls all preferably rest on or near their respective portions of the step 16. Thus, the locking portion 20 preferably encloses a majority of the step 16 and serves as a locking mechanism for the self-locking bracket 12. Optionally, lip 30 may be formed with an extension 31 that extends into the interior of step 16 for further bracket stability and locking.

The self-locking bracket 12 also incorporates a substantial sidewall. The sidewall 32 is best seen on self-locking bracket 14 in FIGS. 1 and 3. This sidewall 32 preferably serves as a support in contact with the ladder support 34, which is generally orthogonal to the step 16. This feature adds stability to the work piece support.

Additionally, the width W of the self-locking bracket 12 is another important feature. As best seen in FIG. 3, the width W is preferably significantly less than the width of the step 16. Therefore, even when two self-locking brackets 12, 14 are used for a work piece support 10 they claim a relatively small portion of the step 16 (e.g., less than one-half the width of the step, and more preferably less than one-quarter) and allow the technician to still use all the steps and workable space of the ladder 36. Moreover, the width of brackets 10, 12 is preferably substantially the same along the length of brackets 10, 12 from the outside edges of support and locking portions 18, 20, respectively.

In use, the v-shaped channels 22, 38 receive the work pieces. When these work pieces are resting in either or both of the v-shaped channels 22, 38 they will exert a downward force on the support portions 18, 40. Again since the self-locking brackets 12, 14 are identical it is only necessary to describe the forces in one self-locking bracket 12 in order to understand the forces in both. This downward force on the support portion 18 creates an overall rotational force in the self-locking bracket 12 pivoting on the corner at the intersection of the top wall 26 and front wall 24 of the locking portion 20. Looking at the self-locking bracket 12 in FIG. 2, the entire piece experiences a counterclockwise force. The lip 30 is crucial in preventing the self-locking bracket 12 from rotating off of the step 16. When properly mounted, as in FIG. 1, the lip 30 will preferably press against the bottom of the step 16 in the event of this force and keep the self-locking bracket 12 in place. Therefore, in the present embodiment the two self-locking brackets 12, 14 form a work piece support 10 that can safely hold various work pieces and preferably conduits of varying diameters.

More particularly, the work piece support 10 preferably also serves as a brace when a technician needs to cut a work piece. First, the work piece is securely placed in the work piece supports 10, as described previously. Then the technician will slide the work piece in the work piece support 10 until the excess length of the work piece is entirely on the outside of one of the self-locking brackets 12, 14, and preferably a corresponding one of ladder supports 34, 36. Then the technician may remove the excess length of the work piece using any standard tool, commonly a saw. When using a saw to remove the excess length of a work piece a multitude of forces will propagate through the work piece and exert various forces on the work piece support 10. Preferably, both of the self-locking brackets 12, 14 fit snugly around the step 16 and thus prevent these forces from jarring either self-locking bracket 12, 14 loose during this high load application. The work piece support also prevents excessive movement of the work piece when the excessive length is being removed. The preferably two self-locking brackets 12, 14 keep the work piece in a generally static state thus ensuring an accurate and safe cut of the work piece.

Overall, work piece support apparatus 10 allows the technician to readily secure a work piece to a support such as a ladder for further manipulation, e.g., cutting. Apparatus 10 requires no separate locking mechanism and is readily transportable, over, for example, on a tool belt of the technician. A range of work pieces are contemplated.

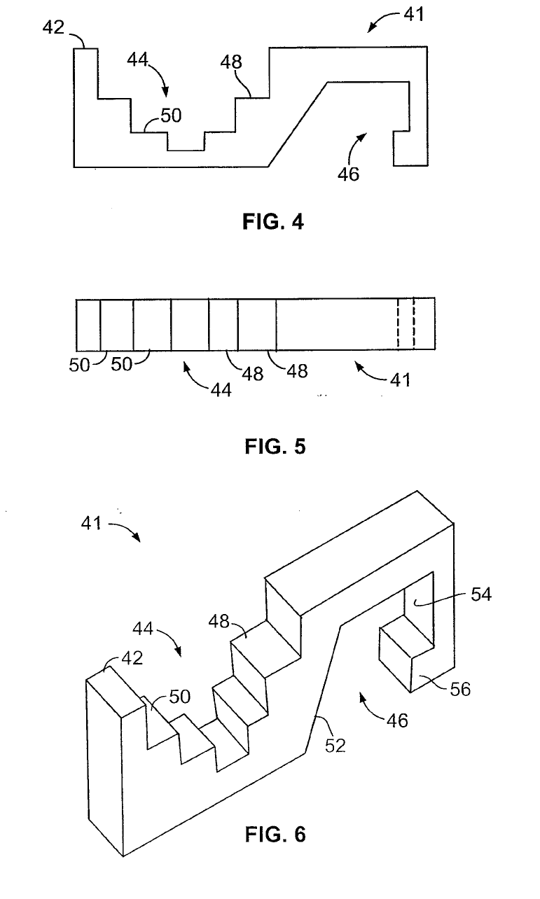

Referring to FIG. 4, according to an alternate embodiment, a work piece support 41 having a step shaped profile is provided to support a variety of different types of correspondingly-shaped work pieces. A work piece support 41 is configured to ideally accommodate several sizes of dimensional lumber. Work piece support 41 includes a bracket 42, preferably self-locking, having a support portion 44 and a locking portion 46. Support portion 44 preferably has a substantially v-shaped channel similar to the previously described embodiment, but with legs 48, 50 of the “v-shape” being stepped to securely retain square shaped work pieces. By stepping legs 48, 50 in this fashion, square shaped work pieces of varying dimensions such as dimensional lumber can be accommodated.

Referring next to FIG. 6, locking portion 46 of self-locking bracket 42 has a front wall 52, a rear wall 54 and a lip portion 56 adapted to engage a step of the ladder as described previously. Locking portion 46 is essentially the same as locking portion 20 of the embodiment shown in FIGS. 1-3. Optionally, lip portion 56 can be formed with an extension, such as that shown in FIG. 2, that extends into the interior of a step of the ladder for improved retention of bracket 42 on the ladder. In use, stepped channel 44 receives and supports the work piece for manipulation by the user, e.g., cutting, etc. Apparatus 41 can be used either one bracket at a time or as shown with the previously described embodiment in pairs to provide further stability of the work piece. Moreover, though v-shaped channels have been shown, and in this case a stepped v-shaped channel for accommodating square shaped work pieces, channel 44 may be shaped to accommodate the corresponding shape of any desired work piece to be operated on.

While this invention has been described with specific embodiments thereof, it is evident that many alternatives, modifications, and variations will be apparent to those skilled in the art. For example, various features of the embodiments are interchangeable with various similar features of other disclosed embodiments. Thus, all of the features disclosed with respect to each embodiment can be applied to the other embodiments to achieve desirable results. Accordingly, the preferred embodiments of the invention as set forth herein are intended to be illustrative, not limiting. Various changes may be made without departing from the spirit and scope of the invention.

We claim:

1. A work piece support for mounting to a ladder, the support comprising:
at least one self-locking bracket including a locking portion to engage a step of the ladder, and a support portion that secures a work piece;
wherein the locking portion and support portion comprise one substantially self-contained unitary member.

2. The work piece support of claim 1, wherein the self-locking bracket support portion has a v-shaped cross-section to accommodate work pieces of different dimensions.

3. The work piece support of claim 2, wherein the work piece is a conduit of varying dimensions.

4. The work piece support of claim 3, wherein the varying dimension is the diameter of the conduit.

5. The work piece support of claim 1, wherein the work piece support is made from polyethylene having some elasticity.

6. The work piece support of claim 1, wherein the self-locking bracket locking portion has a cross-section generally corresponding to the cross-section of the step on the ladder.

7. The work piece support of claim 6, wherein the self-locking bracket locking portion comprises;
a backside wall having a bottom portion; and
a lip extending from the bottom portion of the backside wall towards the self-locking bracket support portion;
wherein the backside wall is a sufficient distance from the support portion to accommodate the cross-section of a step on the ladder and the lip extends a distance from the backside wall to fit under a portion of the step and secure the work piece support to the step.

8. The work piece support of claim 7, further comprising sidewalls that engage an upright support of a ladder that is generally orthogonal to the steps of a ladder.

9. The work piece support of claim 1, wherein the width of the work piece support is less than half the width of the step.

10. The work piece support of claim 1, wherein the width of the work piece support is less than a quarter of the width of the step.

11. The work piece support of claim 1, wherein the width of the work piece support is a single width along its length.

12. The work piece support of claim 1, wherein the support portion has a stepped cross-sectional shape.

13. The work piece support of claim 12, wherein the work piece support is adapted to receive one or more sizes of dimensional lumber.

14. The work piece support of claim 1, wherein the at least one self-locking bracket includes a pair of spaced self-locking brackets.

15. A work piece support for mounting to a ladder, the support comprising;
at least one self-locking bracket including a locking means that engages a step of the ladder, and a support means that secures a work piece;
wherein the locking portion and support portion comprise one self-contained substantially unitary member.

16. The work piece support of claim 15, wherein the locking portion has at least one of a v-shaped cross-sectional shape and a stepped cross-sectional shape.

17. A work piece support for mounting to a ladder, the support comprising:
at least one self-locking bracket including a locking portion to engage a step of the ladder, and a support portion that secures a work piece;
wherein the locking portion and support portion comprise one substantially self-contained unitary member;
wherein the self-locking bracket locking portion comprises;
a backside wall having a bottom portion;
a lip extending from the bottom portion of the backside wall towards the self-locking bracket support portion; and,
wherein the backside wall is a sufficient distance from the support portion to accommodate the cross-section of a step on the ladder and the lip extends a distance from the backside wall to fit under a portion of the step and secure the work piece support to the step.
